(19) United States
(12) Patent Application Publication
(10) Pub. No.: US 2014/0267226 A1
(43) Pub. Date: Sep. 18, 2014

(54) Method and System for Geographic-Oriented Graphical Representation of Multivariable Input Data Set

(71) Applicant: Harry Yoon, San Ramon, CA (US)

(72) Inventor: Harry Yoon, San Ramon, CA (US)

(21) Appl. No.: 13/802,647

(22) Filed: Mar. 13, 2013

(51) Int. Cl. G06T 15/10

(52) U.S. Cl. CPC G06T 15/10
USPC 345/419

(57) ABSTRACT

Methods and systems for computerized geographic-oriented graphical representation of multivariable input data sets are disclosed. In one embodiment, a graphical rendering application programming interface and a graphical rendering engine are configured to correlate the multivariable input data sets and other variables with geographical categories represented from geographic and map-related data, which are represented on a three-dimensional globe. In one example, the multivariable input data sets include a first input data set and a second input data set with multiple variables. A first member of the first input data set is represented as a sphere or a cube on top of a particular national or state boundary on the three-dimensional globe. Furthermore, a first member of the second input data set is represented as a stick erected from a geographic landmark, wherein the stick pierces the sphere or the cube representing the first member of the first input data set.

### FIELD OF THE INVENTION

The present invention generally relates to information processing for intuitive visual representation of input data using one or more computerized systems and related methods. In particular, at least some embodiments of the present invention relate to methods and systems for geographic-oriented graphical representation of multivariable input data set.

### BACKGROUND OF THE INVENTION

In the last several decades, computerized systems, such as personal computers (PC's), mainframe computers, mobile electronic devices, and other electronic devices, have been utilized for visual representation of a variety of input data on a display panel. In many cases, the visual representation of input data using a computerized system is part of an attempt to analyze input data more intuitively, and is also part of an endeavor to conceptualize a theme, a pattern, or a paradigm arising from the input data. In some instances, a mere graphical representation of input data as pie charts, bar graphs, or other conventional charts and/or graphs is sufficient for the visual representation of the input data. In other instances, mathematical transformations using differential equations, logarithmic calculations, and other mathematical formulas are applied to the input data to derive resulting values, which are then represented by pie charts, bar graphs, or other conventional charts and/or graphs.

Conventional methods of visualizing data, such as pie charts, bar graphs, or other conventional charts and/or graphs, are suitable for representing a low number of variables and elements, but they are often unintuitive or unsuitable in representing a complex set of multivariable input data. For a complex set of multivariable input data, it is more common to visualize them in a multi-dimensional table or another tabular representation, instead of conventional pie charts, bar graphs, or other conventional charts and/or graphs.

Furthermore, if data visualization involves multiple geographic regions, such as multiple national and/or state boundaries, conventional charts and/or graphs are generally unsuitable for representing a large number of nation-associated or state-associated data sets that require geographic categorization. At best, a long table listing certain data sets categorized by nations, states, and other geographic boundaries may be utilized to represent the large number of nation-associated or state-associated data sets.

Therefore, for convenient data analysis of nation-associated, state-associated, and/or other geographic boundary-associated data sets, it may be beneficial to devise a computerized system for geographic-oriented graphical representation of multivariable data sets. Furthermore, it may also be beneficial to device a novel method which can be executed on a CPU and a memory unit of the computerized system for geographic-oriented graphical representation of multivariable data sets. In addition, it may also be beneficial to devise a novel user interface operated by the computerized system to configure, visualize, and analyze nation-associated, state-associated, and/or other geographic boundary-associated data sets.

### SUMMARY

Summary and Abstract summarize some aspects of the present invention. Simplifications or omissions may have been made to avoid obscuring the purpose of the Summary or the Abstract. These simplifications or omissions are not intended to limit the scope of the present invention.

In one embodiment of the invention, a computerized system generating a geographic-oriented graphical representation of multivariable input data sets is disclosed. This computerized system comprises: a graphical rendering application programming interface configured to receive the multivariable input data sets, one or more sets of viewing options, and geographic and map-related data, wherein the multivariable input data sets comprise at least a first input data set and a second input data set; a graphical rendering engine configured to process and correlate the multivariable input data sets, the one or more sets of viewing options, and the geographic and map-related data to create a graphical representation of a rotatable three-dimensional image of Earth, a sphere or a cube on top of a particular national or state boundary on the rotatable three-dimensional image of Earth, and a stick erected in the particular national or state boundary piercing the sphere or the cube, wherein the sphere or the cube represents a first member of the first input data set and the sphere's or the cube's volume represents a magnitude of the first member of the first input data set, and wherein the stick piercing the sphere or the cube represents a first member of the second input data set and the stick's height represents a magnitude of the first member of the second input data set; a memory unit and at least one of a central processing unit and a graphics processor unit executing the graphical rendering application programming interface and the graphical rendering engine to generate the graphical representation of the rotatable three-dimensional image of Earth, the sphere or the cube on top of the particular national or state boundary on the rotatable three-dimensional image of Earth, and the stick erected in the particular national or state boundary piercing the sphere or the cube; and a display driver operatively connected to a display panel for displaying the graphical representation provided by the graphical rendering application programming interface and the graphical rendering engine executed in the memory unit and at least one of the central processing unit and the graphics processor unit.

In another embodiment of the invention, a method of generating a computerized geographic-oriented graphical interface for multivariable input data sets is disclosed. This method comprises the steps of: executing one or more programs associated with graphical rendering application programming interfaces (API's) and one or more graphical rendering engines in a CPU, a GPU, a memory unit, and/or another hardware unit in an computerized system; uploading multivariable data sets, viewing options, other input variables, and geographic and map-related data to the CPU, the GPU, the memory unit, and/or another hardware unit in the computerized system; enabling a user to adjust the viewing options and user preferences for geographic-oriented graphical representation of the multivariable data sets uploaded to the CPU, the GPU, the memory unit, and/or another hardware unit in the computerized system; correlating the multivariable data sets and the other input variables with geographical categories from the geographic and map-related data, which are represented on a three-dimensional globe, wherein the multivariable data sets comprise at least a first input data set and a second input data set; representing a first member of the first input data set as a sphere or a cube on top of a particular national or state boundary on the three-dimensional globe, wherein the sphere's volume or the cube's volume represents a magnitude of the first member of the first input data set; representing a first member of the second input data set as a stick erected from a geographic landmark, wherein the stick pierces the sphere or the cube representing the first member of the first input data set within the particular national or state boundary on the three-dimensional globe, and wherein the stick's height represents a magnitude of the first member of the second input data set; and displaying the three-dimensional globe, the sphere or the cube on top of the particular national or state boundary, and the stick piercing the sphere or the cube on a display panel, which is operatively connected to the computerized system.

### BRIEF DESCRIPTION OF DRAWINGS

FIG. 1 shows a first example of a geographic-oriented graphical representation of multivariable input data sets processed by a graphical rendering application programming interface and a graphical rendering engine executed on a CPU and a memory unit of a computerized system, in accordance with an embodiment of the invention.

FIG. 2 shows a second example of a geographic-oriented graphical representation of multivariable input data sets processed by a graphical rendering application programming interface and a graphical rendering engine executed on a CPU and a memory unit of a computerized system, in accordance with an embodiment of the invention.

FIG. 3 shows a third example of a geographic-oriented graphical representation of multivariable input data sets processed by a graphical rendering application programming interface and a graphical rendering engine executed on a CPU and a memory unit of a computerized system, in accordance with an embodiment of the invention.

FIG. 4 shows an example of a user interface with an input variables and input options menu and a graph viewing options menu for a geographic-oriented graphical representation of multivariable input data sets, in accordance with an embodiment of the invention.

FIG. 5 shows a conceptual dataflow diagram of multivariable input data sets processed by a computerized system, which is configured to generate a geographic-oriented graphical representation of the multivariable input data sets, in accordance with an embodiment of the invention.

FIG. 6 shows a hardware block diagram of a computerized system, which is configured to generate a geographic-oriented graphical representation of the multivariable input data sets, in accordance with an embodiment of the invention.

FIG. 7 shows a flowchart for a method of generating a computerized geographic-oriented graphical interface for multivariable input data sets, in accordance with an embodiment of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The detailed description is presented largely in terms of procedures, logic blocks, processing, and/or other symbolic representations that directly or indirectly resemble a system or a method for geographic-oriented graphical representation of multivariable input data set. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment. Furthermore, separate or alternative embodiments are not necessarily mutually exclusive of other embodiments. Moreover, the order of blocks in process flowcharts or diagrams representing one or more embodiments of the invention do not inherently indicate any particular order nor imply any limitations in the invention.

In general, embodiments of the invention relate to one or more computerized systems for generating a geographic-oriented graphical representation of multivariable input data sets. Embodiments of the invention also relate to a method for generating a geographic-oriented graphical representation of multivariable input data sets. In addition, embodiments of the invention also relate to a method of generating a computerized geographic-oriented graphical interface for multivariable input data sets.

For the purpose of describing the invention, a term “computerized system” is defined as a personal computer (PC), a notebook computer, a tablet computer, a mobile communication device (e.g. a smart phone), a mainframe computer, or another electronic device with a central processing unit (CPU) and a memory unit which can execute a series of programming instructions.

Moreover, for the purpose of describing the invention, a term “variable” refers to a symbol that can be assigned with one or more numerical values or symbolic values. For example, a “single variable” refers to a single symbol that can be assigned with a numerical or symbolic value. Likewise, a term “multivariable” refers to a group of symbols that can be assigned with a multiple number of values.

Furthermore, for the purpose of describing the invention, a term “member” is defined as a data set entry that includes multiple elements per member, wherein each member of a particular data set comprises multiple elements of same variable types and combination. For example, if a first “member” of a particular input data set includes three elements per member, then the first “member” may have a particular combination of three variable types (e.g. x, y, z). Following this example, a second “member” of the same particular input data set includes three elements per member with the same variable types and combination (e.g. x, y, z). Furthermore, in one example, each “member” of a particular data set may be associated with a particular nation, a particular sate, or a particular geographic boundary.

FIG. 1 shows a first example (100) of a geographic-oriented graphical representation of multivariable input data sets processed by a graphical rendering application programming interface and a graphical rendering engine executed on a CPU and a memory unit of a computerized system, in accordance with an embodiment of the invention. In a preferred embodiment of the invention, the graphical rendering application programming interface executed on the CPU and the memory unit of the computerized system receives multivariable input data sets. Preferably, the multivariable input data sets comprise at least a first input data set and a second input data set. The graphical rendering application programming interface can also receive one or more sets of viewing options and geographic and map-related data.

In one embodiment of the invention, each multivariable input data set includes at least one “member,” wherein each member incorporates multiple elements. For example, a first input data set may represent a first measure of economic returns on education by including the following three variables: (a) private or public nature of an educational institution, (b) a particular level of the educational institution, (c) a rate of return on education. In this example, because the first input data set has a multiple number of variables, (a), (b), and (c), it is a “multivariable input data set.” Furthermore, for this example, each “member” in the first input data set has three values associated with the three variables, (a), (b), and (c). A first “member” of the first input data set may contain “public institution” for the value associated with variable (a), “tertiary education level” for the value associated with variable (b), and “125 percent per year” for the value associated with variable (c). Preferably, each “member” of the first input data set is also associated with a geographical marker such as a particular national or state boundary. Therefore, the first member in the first input data set example may be associated with the a particular nation, such as Canada. Likewise, a second member of the first input data set contains values for the three variables, (a), (b), and (c), and may be associated with another nation, such as the United States.

Furthermore, continuing with the example described above, a second input data set may represent a second measure of economic returns on education by including the following four variables: (a) gender of an individual or a group, (b) private or public nature of an educational institution, (c) a particular level of the educational institution, (d) a net present value (NPV) of the return on education. In this example, because the second input data set has a multiple number of variables, (a), (b), (c), and (d), it is a “multivariable input data set.” For this example, each “member” in the second input data set has four values associated with the four variables, (a), (b), (c), and (d). A first “member” of the second input data set may contain “male” for the value associated with variable (a), “public institution” for the value associated with variable (b), “tertiary education level” for the value associated with variable (c), and “$40,000 USD” for the value associated with variable (d). Preferably, each “member” of the second input data set is also associated with a geographical marker such as a particular national or state boundary. Therefore, the first member in the second input data set may be associated with the a particular nation, such as Canada. Likewise, a second member of the second input data set contains values for the four variables, (a), (b), (c), and (d), and may be associated with another nation, such as the United States.

Continuing with FIG. 1, in a preferred embodiment of the invention, the graphical rendering engine executed by the CPU and the memory unit of the computerized system is configured to process and correlate the multivariable input data sets, the one or more sets of viewing options, and the geographic and map-related data to create the first example (100) of a geographic-oriented graphical representation of a rotatable three-dimensional image of Earth (127). The first example (100) of the geographic-oriented graphical representation also shows a first sphere (107) on top of a map of the United States (101), and a first stick (103) erected in the map of the United States (101). In this embodiment of the invention, the first sphere (107) represents a magnitude of a first member of a first input data set, and the first sphere's volume represents a magnitude of the first member of the first input data set. Furthermore, the first stick (103) piercing the first sphere (107) represents a first member of a second input data set, and the first stick's height represents a magnitude of the first member of the second input data set. In addition, in FIG. 1, a second sphere (105) pierced by the first stick (103) is also on top of the map of the United States (101) on the rotatable three-dimensional image of Earth (127), wherein the second sphere represents a first member of a third input data set and the second sphere's volume represents a magnitude of the first member of the third data set. In one embodiment of the invention, a cube or another object with a specific volume to signify a magnitude of a member in a data set may be utilized in addition to or in lieu of the first sphere (107) or the second sphere (105).

In the preferred embodiment of the invention, each member of a particular input data set is associated with a particular nation, a particular state, or another geographic landmark. For example, in FIG. 1, a second member of the first input data set is represented as a third sphere (111) on top of a map of Canada (109) on the rotatable three-dimensional image of Earth (127), wherein the third sphere's volume represents a magnitude of the second member of the first input data set. Similarly, a second member of the second input data set is represented by a second stick (115) erected in the map of Canada (109), wherein the second stick's height represents a magnitude of the second member of the second input data set. Likewise, a second member of the third input data set is represented by a fourth sphere (113) on top of the map of Canada (109), wherein the fourth sphere (113) is pierced by the second stick (115) and wherein the fourth sphere's volume represents a magnitude of the second member of the third input data set. In one embodiment of the invention, a cube or another object with a specific volume to signify a magnitude of a member in a data set may be utilized in addition to or in lieu of the third sphere (111) or the fourth sphere (113).

FIG. 1 also shows other spheres and sticks (e.g. 117, 119, 121, 123, 125), each of which represents a particular member of a particular multivariable input data set, wherein the particular member is associated with a particular nation, a particular state, or another geographic landmark. Preferably, each member of each input data set is uniquely associated with a particular nation, a particular state, or another particular geographic landmark. Also preferably, each input data set represented by a sphere or a stick piercing the sphere is a multivariable input data set with multiple variables (e.g. variables (a), (b), and (c), as described in an aforementioned example) incorporated in each member of each input data set.

In the embodiment of the invention as shown in FIG. 1, there are three multivariable input data sets that are processed and generated as a unique geographic-oriented graphical representation of the three multivariable input data sets on the rotatable three-dimensional image of Earth (127). In this embodiment of the invention, a member of the first input data set is uniquely represented by a shaded sphere above a map of a particular nation. Furthermore, a member of the second input data set is uniquely represented by a stick piercing the shaded sphere above the map of the particular nation. Moreover, a member of the third input data set is uniquely represented by a white sphere also above the map of the particular nation, wherein the white sphere is also pierced by the stick that represents the member of the second input data set.

Continuing with FIG. 1, the first example (100) of the geographic-oriented graphical representation of the rotatable three-dimensional image of Earth (127) can utilize a computer mouse, a touch-sensitive display panel, or another device to rotate the rotatable three-dimensional image of Earth (127), so that a user can dynamically inspect, zoom-in, zoom-out, and analyze the unique spherical and stick representations of multivariable data sets as disclosed in various embodiments of the present invention, wherein each member of each multivariable data set is associated with a particular nation, a particular state, or another geographic landmark around the globe. In addition, a clickable or a touch-sensitive menu item on a display user interface, such as an “information” icon shown in FIG. 1, can provide more detailed information regarding the geographic-oriented three-dimensional graphical representation of multivariable input data sets on the globe.

Furthermore, in one embodiment of the invention, the rotatable three-dimensional image of Earth (127) can include a visual representation of an inner core underneath a particular national or state boundary with a specific volume for the inner core to symbolize a magnitude of a macroscopic data point. For example, an average value or a median value derived from a multinational, a multi-state, or a multi-regional data point may be represented by the specific volume for the inner core (e.g. 127).

FIG. 2 shows a second example (200) of a geographic-oriented graphical representation of multivariable input data sets processed by a graphical rendering application programming interface and a graphical rendering engine executed on a CPU and a memory unit of a computerized system, in accordance with an embodiment of the invention. In a preferred embodiment of the invention, the graphical rendering application programming interface executed on the CPU and the memory unit of the computerized system receives multivariable input data sets. Preferably, the multivariable input data sets comprise at least a first input data set and a second input data set. The graphical rendering application programming interface can also receive one or more sets of viewing options and geographic and map-related data.

In one embodiment of the invention, each multivariable input data set includes at least one “member,” wherein each member incorporates multiple elements. For example, a first input data set may represent a first measure of economic returns on education by including the following three variables: (a) private or public nature of an educational institution, (b) a particular level of the educational institution, (c) a rate of return on education. In this example, because the first input data set has a multiple number of variables, (a), (b), and (c), it is a “multivariable input data set.” Furthermore, for this example, each “member” in the first input data set has three values associated with the three variables, (a), (b), and (c). A first “member” of the first input data set may contain “public institution” for the value associated with variable (a), “tertiary education level” for the value associated with variable (b), and “125 percent per year” for the value associated with variable (c). Preferably, each “member” of the first input data set is also associated with a geographical marker such as a particular national or state boundary. Therefore, the first member in the first input data set example may be associated with the a particular nation, such as Canada. Likewise, a second member of the first input data set contains values for the three variables, (a), (b), and (c), and may be associated with another nation, such as the United States.

Furthermore, continuing with the example described above, a second input data set may represent a second measure of economic returns on education by including the following four variables: (a) gender of an individual or a group, (b) private or public nature of an educational institution, (c) a particular level of the educational institution, (d) a net present value (NPV) of the return on education. In this example, because the second input data set has a multiple number of variables, (a), (b), (c), and (d), it is a “multivariable input data set.” For this example, each “member” in the second input data set has four values associated with the four variables, (a), (b), (c), and (d). A first “member” of the second input data set may contain “male” for the value associated with variable (a), “public institution” for the value associated with variable (b), “tertiary education level” for the value associated with variable (c), and “$40,000 USD” for the value associated with variable (d). Preferably, each “member” of the second input data set is also associated with a geographical marker such as a particular national or state boundary. Therefore, the first member in the second input data set may be associated with the a particular nation, such as Canada. Likewise, a second member of the second input data set contains values for the four variables, (a), (b), (c), and (d), and may be associated with another nation, such as the United States.

Continuing with FIG. 2, in a preferred embodiment of the invention, the graphical rendering engine executed by the CPU and the memory unit of the computerized system is configured to process and correlate the multivariable input data sets, the one or more sets of viewing options, and the geographic and map-related data to create the second example (200) of a geographic-oriented graphical representation of a rotatable three-dimensional image of Earth (221). The second example (200) of the geographic-oriented graphical representation also shows a first sphere (209) on top of a map of the United States (201), and a first stick (205) erected in the map of the United States (201). In this embodiment of the invention, the first sphere (209) represents a magnitude of a first member of a first input data set, and the first sphere's volume represents a magnitude of the first member of the first input data set. Furthermore, the first stick (205) piercing the first sphere (209) represents a first member of a second input data set, and the first stick's height represents a magnitude of the first member of the second input data set.

In addition, in FIG. 2, a second sphere (207) pierced by the first stick (205) is also on top of the map of the United States (201) on the rotatable three-dimensional image of Earth (221), wherein the second sphere (207) represents a first member of a third input data set and the second sphere's volume represents a magnitude of the first member of the third data set. Furthermore, in the embodiment of the invention as shown in FIG. 2, a second stick (203) is also erected in the map of the United States (201), and the second stick (203) represents a first member of a fourth input data set, and the second stick's height represents a magnitude of the first member of the fourth input data set. In one embodiment of the invention, a cube or another object with a specific volume to signify a magnitude of a member in a data set may be utilized in addition to or in lieu of the first sphere (209) or the second sphere (207).

In the preferred embodiment of the invention, each member of a particular input data set is associated with a particular nation, a particular state, or another geographic landmark. For example, in FIG. 2, a second member of the first input data set is represented as a third sphere (213) on top of a map of Canada (211) on the rotatable three-dimensional image of Earth (221), wherein the third sphere's volume represents a magnitude of the second member of the first input data set. Similarly, a second member of the second input data set is represented by a third stick (215) erected in the map of Canada (211), wherein the second stick's height represents a magnitude of the second member of the second input data set. Likewise, a second member of the third input data set is represented by a fourth sphere (217) on top of the map of Canada (211), wherein the fourth sphere (217) is pierced by a fourth stick (219), which represents a second member of the fourth input data set. The fourth sphere's volume represents a magnitude of the second member of the third input data set, and the fourth stick's height represents a magnitude of the second member of the fourth input data set. In one embodiment of the invention, a cube or another object with a specific volume to signify a magnitude of a member in a data set may be utilized in addition to or in lieu of the third sphere (213) or the fourth sphere (217).

FIG. 2 also shows other spheres and sticks in other regions, each of which represents a particular member of a particular multivariable input data set, wherein the particular member is associated with a particular nation, a particular state, or another geographic landmark. Preferably, each member of each input data set is uniquely associated with a particular nation, a particular state, or another particular geographic landmark. Also preferably, each input data set represented by a sphere or a stick piercing the sphere is a multivariable input data set with multiple variables (e.g. variables (a), (b), (c), and (d), as described in an aforementioned example) incorporated in each member of each input data set.

In the embodiment of the invention as shown in FIG. 2, there are four multivariable input data sets that are processed and generated as a unique geographic-oriented graphical representation of the three multivariable input data sets on the rotatable three-dimensional image of Earth (221). In this embodiment of the invention, a member of the first input data set is uniquely represented by a shaded sphere above a map of a particular nation. Furthermore, a member of the second input data set is uniquely represented by a first stick piercing the shaded sphere above the map of the particular nation. Moreover, a member of the third input data set is uniquely represented by a white sphere also above the map of the particular nation, wherein the white sphere is also pierced by the first stick that represents the member of the second input data set, or alternatively, a second stick that represents a member of the fourth input data set.

Continuing with FIG. 2, the second example (200) of the geographic-oriented graphical representation of the rotatable three-dimensional image of Earth (221) can utilize a computer mouse, a touch-sensitive display panel, or another device to rotate the rotatable three-dimensional image of Earth (221), so that a user can dynamically inspect, zoom-in, zoom-out, and analyze the unique spherical and stick representations of multivariable data sets as disclosed in various embodiments of the present invention, wherein each member of each multivariable data set is associated with a particular nation, a particular state, or another geographic landmark around the globe. In addition, a clickable or a touch-sensitive menu item on a display user interface, such as an “information” icon shown in FIG. 2, can provide more detailed information regarding the geographic-oriented three-dimensional graphical representation of multivariable input data sets on the globe.

Furthermore, in one embodiment of the invention, the rotatable three-dimensional image of Earth (221) can include a visual representation of an inner core underneath a particular national or state boundary with a specific volume for the inner core to symbolize a magnitude of a macroscopic data point. For example, an average value or a median value derived from a multinational, a multi-state, or a multi-regional data point may be represented by the specific volume for the inner core (e.g. 221).

FIG. 3 shows a third example (300) of a geographic-oriented graphical representation of multivariable input data sets processed by a graphical rendering application programming interface and a graphical rendering engine executed on a CPU and a memory unit of a computerized system, in accordance with an embodiment of the invention. In the embodiment of the invention as shown in FIG. 3, the geographic-oriented graphical representation is a computerized user interface processed and generated by the graphical rendering application programming interface and the graphical rendering engine executed on the CPU and the memory unit of a computerized system, such as a PC, a mobile communication device, or another electronic device configured to display a graphical representation on a display panel.

In this embodiment of the invention, the computerized user interface as shown in the third example (300) incorporates a rotatable three-dimensional image of Earth, with a plurality of spheres and a plurality of sticks piercing at least one sphere categorized by a particular nation, a particular region, or another geographic landmark on the rotatable three-dimensional image of Earth. In the particular example as shown in FIG. 3, nationally-categorized multivariable input data sets associated with economic returns on education are generated as a plurality of spheres, cubes, and/or sticks, wherein each stick is erected from a particular national or state boundary and pierces one or more spheres or cubes within that particular national or state boundary.

The geographic-oriented representation of multivariable data sets using a computerized system to generate the plurality of spheres, cubes, and/or sticks, each of which is categorized by national or state boundaries on a rotatable three-dimensional image of Earth, is a novel and unique aspect of various embodiments of the present invention. Preferably, the rotatable three-dimensional image of Earth is a computerized user interface, which is clickable, zoomable, and/or touch-sensitive for graphical representation of the geographic-oriented multivariable data set. In another embodiment of the invention, the computerized user interface may be a rotatable globe, which may symbolize a planet, a moon, or a spherical object other than Earth.

FIG. 4 shows an example (400) of a user interface with an input variables and input options menu (401) and a graph viewing options menu (403) for a geographic-oriented graphical representation of multivariable input data sets, in accordance with an embodiment of the invention. In the embodiment of the invention as shown in FIG. 4, the input variables and input options menu (401) includes a plurality of pull-down sub-menus for setting up a graphical chart. For example, a multivariable “member” of a data set may include the following four variables, as shown in the input variables and input options menu (401): (a) gender information (e.g. male or female) as a first variable, (b) education system (e.g. public or private) as a second variable, (c) education level (e.g. primary, secondary, tertiary, non-tertiary) as a third variable, and (d) gross earnings benefit as a fourth variable.

In a preferred embodiment of the invention, the input variables and input options menu (401) provides a variety of options to configure a graphical chart, data sources, and data setup indicators, which involve selecting and adjusting criteria and values for the four variables and other input options. Furthermore, as shown in FIG. 4, the graph viewing options menu (403) provides a plurality of checkboxes and pull-down sub-menus to select one or more input data sets to be represented as spheres, cubes, and/or sticks piercing the spheres and the cubes.

For example, under the “Charts” sub-menu in the graph viewing options menu (403), “Male, Public, Non-Tertiary/NPV (Net Present Value)” is a first input data set check-boxed, or “selected” to be represented by a first sphere type in each national or state boundary for all members of the first input data set. Likewise, “Female, Private, Tertiary/NPV (Net Present Value)” is a second input data set check-boxed, or “selected” to be represented by a second sphere type in each national or state boundary for all members of the second input data set. Similarly, “Male, Gross Earnings Benefits” is a third input data set check-boxed, or “selected” to be represented by a first stick type in each national or state boundary for all members of the third input data set. In addition, “Female, Gross Earnings Benefits” is a fourth input data set check-boxed, or “selected” to be represented by a second stick type in each national or state boundary for all members of the fourth input data set, as shown in the graph viewing options menu (403) of FIG. 4.

In another embodiment of the invention, other input data sets, such as sub-menu choices (e.g. “Public, Tertiary, Rate of Return,” “Private, Tertiary, Rate of Return,” and etc.) below the four check-boxed selections in the graph viewing options menu (403), can be selected to be represented as spheres, cubes, and/or sticks in certain national or state boundaries for geographic-oriented graphical representation of multivariable data sets. Preferably, a user can configure the graph viewing options menu (403) to correlate a particular data set (e.g. “Male, Public, Non-Tertiary, NPV,” “Public, Total Costs,” “Public, Tertiary, Tax+Transfers,” and etc.) with a sphere, a cube, or another object with a specific volume to signify a magnitude of a member from the particular data set. Then, a graphical rendering application programming interface and a graphical rendering engine executed in a computerized system can generate the sphere, the cube, or another object with a specific volume, which correlates to a particular national boundary, a state boundary, or another geographic boundary on a three-dimensional globe. In a preferred embodiment of the invention, the three-dimensional globe may symbolize Earth. In another embodiment of the invention, the three-dimensional globe may symbolize another planet or another spherical object.

Continuing with FIG. 4, in one embodiment of the invention, the view options sub-menu in the graph viewing options menu (403) can include options such as “geolocated,” “animated,” “focused chart,” and a variety of sorting options. In one embodiment of the invention, if the “geolocated” option is check-boxed, then each member of the selected input data sets will be correlated geographically to its dataset-originating nation or state on a three-dimensional globe, which is typically rotatable in a computerized user interface, as previously shown and described for FIGS. 1˜3. Furthermore, if the “animated” option is check-boxed, then the three-dimensional globe displayed by the computerized user interface can periodically rotate, zoom-in, and/or zoom-out to a certain region of the globe to show geographic-oriented graphical representation of input data sets by nations or states in a computer-animation sequence. In addition, the “focused chart” option allows a user to select a particular input data set, such as “Male, Gross Earnings Benefits” as shown in the “focused cart” pull-down sub-menu in FIG. 4, to highlight or distinguish the selected input data set from the rest of the graphical representations on the three-dimensional globe.

Moreover, sorting options can configure which objects (e.g. spheres, cubes, sticks, and etc.) are displayed topmost per national or state boundary, based on comparisons of magnitudes between multiple members of multiple data sets associated with a particular nation, a particular state, or another geographical boundary. For example, if a sort option is “descending,” an object with the biggest volume (i.e. a member of an input data set with the highest magnitude) is displayed topmost in a particular nation, a particular state, or another geographical boundary. On the other hand, if the sort option is “ascending,” an object with the smallest volume (i.e. a member of an input data set with the lowest magnitude) is displayed topmost in a particular nation, a particular state, or another geographical boundary. In addition, in some embodiments of the invention, other view options such as “particle option” can change the level of granularities for particles that comprise the three-dimensional globe generated by a computerized system.

FIG. 5 shows a conceptual dataflow diagram (500) of multivariable input data sets (501) processed by a computerized system (519), which is configured to generate a geographic-oriented graphical representation of the multivariable input data sets on a display panel (529), in accordance with an embodiment of the invention. In a preferred embodiment of the invention as shown in FIG. 5, the multivariable input data sets (501) comprises at least one multivariable input data set (e.g. 503) for graphical representation. For example, the multivariable input data sets (501) may comprise a first input data set (503), a second input data set (505), a third input data set (507), and any other input data sets up to the “N-th” input data set (509). Preferably, each input data set includes multiple number of variables. As a case in point, each of the twelve checkbox items (e.g. “Male, Public, Non-Tertiary, NPV,” “Female, Private, Tertiary, NPV,” . . . “Tertiary, Social+Unemploy”) under the “Charts” sub-menu in the graph viewing options menu (403) in FIG. 4 is an example of a multivariable input data set.

Furthermore, in the embodiment of the invention as shown in FIG. 5, the conceptual dataflow diagram (500) also shows one or more sets of viewing options (511), which comprises at least one set of viewing options. In one example, a first set of viewing options (513), a second set of viewing options (515), and any other sets of viewing options up to the “N-th” set of viewing options (517) can be part of the one or more sets of viewing options (511). In addition, geographic and map-related data (531) can be stored in a data storage and then at some point loaded onto a memory unit and a CPU of the computerized system (519) in one embodiment of the invention. The geographic and map-related data (531) may include a rotatable three-dimensional image of a globe (e.g. a rotatable three-dimensional image of Earth) as well as national, state, and/or other geographic border information that can be associated with the rotatable three-dimensional image of the globe, if rendered appropriately by a graphical rendering application programming interface (API) (521) and a graphical rendering engine (523) of the computerized system (519).

In the embodiment of the invention as shown in FIG. 5, the graphical rendering application programming interface (API) (521) operating in the computerized system (519) is configured to receive the multivariable input data sets (501), the one or more sets of viewing options (511), and the geographic and map-related data (531). Preferably, the multivariable input data sets (501) contain at least the first input data set (503) and the second input data set (505). Furthermore, the graphical rendering engine (523) executed in the memory unit and the CPU of the computerized system (519) is configured to process and correlate the multivariable input data sets (501), the one or more sets of viewing options (511), and the geographic and map-related data (531) to create a graphical representation of a three-dimensional image of Earth, a sphere or a cube on top of a particular national or state boundary on the three-dimensional image of Earth, and a stick erected in the particular national or state boundary piercing the sphere or the cube. In one embodiment of the invention, the sphere or the cube represents a first member of the first input data set (503), and the volume of the sphere or the cube represents a magnitude of the first member of the first input data set (503). Furthermore, in one embodiment of the invention, the stick piercing the sphere or the cube represents a first member of the second input data set (505), and the stick's height represents a magnitude of the first member of the second input data set (505). Preferably, the three-dimensional image of Earth is a graphical user interface that can be rotated, zoomed-in, and/or zoomed-out by a mouse, a user's touch on a touch-sensitive display screen, eye movements detected by a webcam, or another user interface device operatively connected to the computerized system (519).

Continuing with FIG. 5, in one embodiment of the invention, the computerized system (519) includes a program execution unit (525) comprising at least one of a graphical processor unit (GPU), a central processing unit (CPU), a memory unit, and/or another hardware unit. This program execution unit (525) can load information from the multivariable input data sets (501), the one or more sets of viewing options (511), and the geographic and map-related data (531). Furthermore, the program execution unit (525) can execute the graphical rendering API (521) and the graphical rendering engine (523) to generate the graphical representation of the rotatable three-dimensional image of Earth, the sphere or the cube on top of the particular national or state boundary on the rotatable three-dimensional image of Earth, and the stick erected in the particular national or state boundary piercing the sphere or the cube. Then, the graphical representation generated by the program execution unit (525) can be displayed by a display panel (529) operatively connected to the computerized system (519). Preferably, a display driver (527) operatively connected to the program execution unit (525) transforms, converts, and/or processes the graphical representation generated by the program execution unit (525) for driving the display panel (529) with correct display data signals and display control signals.

FIG. 6 shows a hardware block diagram (600) of a computerized system (625), which is configured to generate a geographic-oriented graphical representation of the multivariable input data sets, in accordance with an embodiment of the invention. In a preferred embodiment of the invention, the computerized system (625), which is configured to generate a geographic-oriented graphical representation of multivariable input data sets, has a CPU (601) which is operatively connected to a memory unit (613), a graphics rendering, maps, and multivariable input data set storage (605), a graphics unit (607) (e.g. a graphics processor, a display driver, and etc.), a power management unit (609), and a peripheral device and/or external I/O interface unit (611). In some embodiments of the invention, if the computerized system (625) is a mobile communication device or another portable electronic device, it may also optionally include at least one of a camera processing unit (603), a GPS and/or location tracking unit (617), and a digital signal processing unit (615) for cellular or wireless network communication. These logical units may be placed on a single printed circuit board (625) in one embodiment of the invention, or a plurality of printed circuit boards in another embodiment of the invention.

In the preferred embodiment of the invention, the CPU (601) is configured to control each logical unit operatively (i.e. directly or indirectly) connected to the CPU (601). The memory unit (613) typically comprises volatile memory banks based on DRAM's. In some embodiments of the invention, the memory unit (613) may use non-volatile memory technologies such as SRAM's and/or Flash memory. The memory unit (613) is capable of storing programs and applications which can be executed by the CPU (601), the graphics unit (607), or another logical unit operatively connected to the memory unit (613). In particular, in the preferred embodiment of the invention, a graphical rendering application programming interface (API), a graphical rendering engine, and/or other software executed on the CPU (601) and the memory unit (613) of the computerized system (625) creates a rotatable three-dimensional image of Earth, a sphere or a cube on top of a particular national or state boundary on the rotatable three-dimensional image of Earth, and a stick erected in the particular national or state boundary piercing the sphere or the cube. Any software and programs executed on the CPU (601) and the memory unit (613) of the computerized system (625) may be part of an operating system, or a separate application installed on the operating system of the computerized system (625). Furthermore, in one embodiment of the invention, the graphics rendering, maps, and multivariable input data set storage (605) is configured to store graphical rendering-related information, geographic and map-related data, multivariable input data sets, and any other relevant data received or processed by the computerized system (625).

Continuing with FIG. 6, in some embodiments of the invention, the camera processing unit (603) is operatively connected to a camera lens on the computerized system (625), and is able to process image-related data from the camera lens in association with the CPU (601) and/or other logical units in the computerized system to produce live recorded video information, which may be stored in the graphics rendering, maps, and multivariable input data set storage (605). In one embodiment of the invention, the live recorded video information can be used as part of an augmented reality application to correlate at least some data from the multivariable input data sets and geographic boundaries with the live recorded video information for graphical rendering on a rotatable three-dimensional image of Earth.

Moreover, the GPS and/or location tracking unit (617) may comprise a GPS signal receiver and/or another real-time location tracking chip, which enable the computerized system (625) to detect and determine the real-time change in location and position of the computerized system (625) or another location-tracked device. In one embodiment of the invention, the GPS and/or location tracking unit (617) can provide GPS coordinates and other relevant data to the graphical rendering API and the graphical rendering engine loaded to the memory unit (613), so that the geographic-oriented graphical representation generated by the computerized system (625) can also incorporate real-time location information of the computerized system (625) in a rotatable three-dimensional image of Earth.

Furthermore, as shown in FIG. 6, in one embodiment of the invention, the digital signal processing (DSP) unit for cellular and/or wireless network communication (615) is operatively connected to a radio frequency (RF) antenna. The DSP unit (615) is generally configured to receive and transmit radio data and/or voice signals wirelessly for a mobile communication device that functions as the computerized system (625). In addition, the power management unit (609) is operatively connected to a power supply unit and a power source (e.g. battery, power adapter) (621), and the power management unit (609) generally controls power supplied to the computerized system (625) and its logical units. Moreover, the peripheral device and/or external communication I/O interface (611) as shown in FIG. 6 can be operatively connected to one or more peripheral devices, wireless devices, network interfaces, USB ports, and other external data communication media (623).

Continuing with FIG. 6, in the preferred embodiment of the invention, the graphics unit (607) in the hardware block diagram (600) for the computerized system (625) comprises a graphics processor unit (GPU), a display driver, a dedicated graphics memory unit, and/or another graphics-related logical components. In general, the graphics unit (607) is able to process and communicate graphics-related data among the CPU (601), the display driver, and/or the dedicated graphics memory unit. The graphics unit (607) is also operatively connected to one or more display panels (619). In addition, in one embodiment of the invention, the CPU (601) may also be operatively connected to a sound unit which contains audio-related logical components for generation or recording of audio data from a microphone operatively connected to the computerized system (625).

FIG. 7 shows a flowchart (700) for a method of generating a computerized geographic-oriented graphical interface for multivariable input data sets, in accordance with an embodiment of the invention. In the embodiment of the invention as shown in FIG. 7, a computerized system executes one or more programs associated with graphical rendering API(s) and graphical rendering engine(s) in a CPU, a GPU, a memory unit, and/or another hardware unit of the computerized system, as shown in STEP 701. This computerized system may be a PC computer system, a mobile electronic device, or another electronic device.

Then, the computerized system can upload multivariable input data set(s) and other input variables in the CPU, the GPU, the memory unit, and/or another hardware unit of the computerized system, as shown in STEP 702. Subsequently, a user interface generated by the computerized system can enable a user to adjust viewing options and other user preferences for geographic-oriented graphical representation of the uploaded multivariable input data set(s), as shown in STEP 703. Once the viewing options and other user preferences are configured, then the computerized system can correlate the uploaded multivariable input data set(s) and other input variables with geographical categories represented on a three-dimensional globe, as shown in STEP 704.

The computerized system can then generate the computerized geographic-oriented graphical interface that represents a member of a first input data set as a sphere or a cube on top of a particular national boundary or another geographically-defined boundary on a three dimensional globe, wherein the volume of the sphere or the cube represents the magnitude of the member of the first input data set, as shown in STEP 705. The computerized geographic-oriented graphical interface can also represent a member of a second input data set as a stick erected from a geographic landmark, wherein the stick pierces the sphere or the cube representing the member of the first input data set within the particular national boundary or another geographically-defined boundary on the three-dimensional globe. Preferably, the height of the stick piercing the sphere or the cube represents the magnitude of the member of the second input data set, as shown in STEP 706. Then, the computerized system can repeat STEP 705 and STEP 706 until all or user interface viewing option-defined members of the first input data set and the second input data set are geographically represented in the three-dimensional globe.

As shown and described above, various embodiments of the present invention provide one or more computerized systems for geographic-oriented graphical representation of multivariable data sets. In addition, various embodiments of the present invention also provide novel methods which can be executed on CPU's and memory units of these computerized systems for geographic-oriented graphical representation of multivariable data sets. Furthermore, one or more embodiments of the present invention also provide novel user interfaces operated by one or more computerized systems to configure, visualize, and analyze nation-associated, state-associated, and/or other geographic boundary-associated data sets.

Many of these embodiments of the present invention provide several advantages over conventional methods of visualizing data, such as pie charts, bar graphs, or other conventional charts and/or graphs. Unlike the conventional computerized visualization methods of data that are mostly suitable for representing a low number of variables and elements, one or more embodiments of the present invention provide intuitive, coherent, and unique way of visualizing a complex set of multivariable input data on a three-dimensional and rotatable image of Earth or on another rotatable globe.

Furthermore, for data visualization correlated to multiple geographic regions, such as multiple national and/or state boundaries, one or more embodiments of the present invention provide a novel and intuitive geographic-oriented graphical representation of multivariable input data sets by creating a rotatable three-dimensional image of Earth or another rotatable globe, a sphere or a cube on top of a particular national or state boundary on the rotatable three-dimensional image of Earth or another rotatable globe, and a stick erected in the particular national or state boundary piercing the sphere or the cube, wherein the sphere, the cube, and the stick each represents a particular member of a particular multivariable input data set categorized by nations, states, or another geographical distinction.

Moreover, the novel and intuitive geographic-oriented graphical representations of multivariable input data sets as shown in one or more embodiments of the present invention enable convenient data analysis of nation-associated, state-associated, and/or other geographic boundary-associated data sets.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computerized system generating a geographic-oriented graphical representation of multivariable input data sets, the computerized system comprising:
a graphical rendering application programming interface configured to receive the multivariable input data sets, one or more sets of viewing options, and geographic and map-related data, wherein the multivariable input data sets comprise at least a first input data set and a second input data set;
a graphical rendering engine configured to process and correlate the multivariable input data sets, the one or more sets of viewing options, and the geographic and map-related data to create a graphical representation of a rotatable three-dimensional image of Earth, a sphere or a cube on top of a particular national or state boundary on the rotatable three-dimensional image of Earth, and a stick erected in the particular national or state boundary piercing the sphere or the cube, wherein the sphere or the cube represents a first member of the first input data set and the sphere's or the cube's volume represents a magnitude of the first member of the first input data set, and wherein the stick piercing the sphere or the cube represents a first member of the second input data set and the stick's height represents a magnitude of the first member of the second input data set;
a memory unit and at least one of a central processing unit and a graphics processor unit executing the graphical rendering application programming interface and the graphical rendering engine to generate the graphical representation of the rotatable three-dimensional image of Earth, the sphere or the cube on top of the particular national or state boundary on the rotatable three-dimensional image of Earth, and the stick erected in the particular national or state boundary piercing the sphere or the cube; and
a display driver operatively connected to a display panel for displaying the graphical representation provided by the graphical rendering application programming interface and the graphical rendering engine executed in the memory unit and at least one of the central processing unit and the graphics processor unit.

2. The computerized system of claim 1, wherein a second member of the first input data set and a second member of the second input data set are associated with another national or another state boundary outside the particular national or state boundary associated with the first member of the first input data and the first member of the second input data set.

3. The computerized system of claim 1, wherein the multivariable input data sets further comprise a third input data set and a fourth input data set.

4. The computerized system of claim 3, wherein the graphical rendering engine further creates an additional graphical representation of a second sphere or a second cube on top of the particular national or state boundary on the rotatable three-dimensional image of Earth, wherein the second sphere or the second cube represents a first member of the third input data set and the second sphere's volume or the second cube's volume represents a magnitude of the first member of the third input data set.

5. The computerized system of claim 4, wherein the graphical rendering engine further creates the additional graphical representation of a second stick erected in the particular national or state boundary piercing the second sphere or the second cube, wherein the second stick piercing the second sphere or the second cube represents a first member of the fourth input data set, and wherein the second stick's height represents a magnitude of the first member of the fourth input data set.

6. The computerized system of claim 1, wherein the rotatable three-dimensional image of Earth further includes an inner core underneath the particular national or state boundary with a specific volume that represents an average value, a median value, or another value derived from the multivariable input data sets.

7. The computerized system of claim 1, further comprising a graphics rendering, maps, and multivariable input data set storage operatively connected to the memory unit and at least one of the central processing unit and the graphics processor unit.

8. The computerized system of claim 1, further comprising a peripheral device and external communication interface for data connection to peripheral devices, wireless devices, network interfaces, and USB ports.

9. The computerized system of claim 1, further comprising a user interface generated on a touch-sensitive menu displayed on the display panel, wherein the user interface is operatively connected to the graphical rendering application programming interface for entering or adjusting user inputs associated with the multivariable input data sets, the one or more sets of viewing options, and the geographic and map-related data.

10. The computerized system of claim 8, further comprising a mouse, a webcam, a keyboard, and/or a microphone, which are operatively connected to the peripheral device and external communication interface for entering or adjusting user inputs associated with the multivariable input data sets, the one or more sets of viewing options, and the geographic and map-related data.

11. The computerized system of claim 1, further comprising a power management unit operatively connected to the central processing unit and a power source.

12. The computerized system of claim 1, further comprising a camera processing unit operatively connected to a camera lens for providing camera-captured images for the geographic and map-related data and for the graphical rendering application programming interface.

13. The computerized system of claim 1, further comprising a GPS-based location tracking unit for providing location information to the geographic and map-related data.

14. The computerized system of claim 1, further comprising a digital signal processing unit for providing a cellular network-based or another wireless network-based data communication for the geographic-oriented graphical representation of the multivariable input data sets.

15. A method of generating a computerized geographic-oriented graphical interface for multivariable input data sets, the method comprising the steps of:
executing one or more programs associated with graphical rendering application programming interfaces (API's) and one or more graphical rendering engines in a CPU, a GPU, a memory unit, and/or another hardware unit in an computerized system;
uploading multivariable data sets, viewing options, other input variables, and geographic and map-related data to the CPU, the GPU, the memory unit, and/or another hardware unit in the computerized system;
enabling a user to adjust the viewing options and user preferences for geographic-oriented graphical representation of the multivariable data sets uploaded to the CPU, the GPU, the memory unit, and/or another hardware unit in the computerized system;
correlating the multivariable data sets and the other input variables with geographical categories from the geographic and map-related data, which are represented on a three-dimensional globe, wherein the multivariable data sets comprise at least a first input data set and a second input data set;
representing a first member of the first input data set as a sphere or a cube on top of a particular national or state boundary on the three-dimensional globe, wherein the sphere's volume or the cube's volume represents a magnitude of the first member of the first input data set;
representing a first member of the second input data set as a stick erected from a geographic landmark, wherein the stick pierces the sphere or the cube representing the first member of the first input data set within the particular national or state boundary on the three-dimensional globe, and wherein the stick's height represents a magnitude of the first member of the second input data set; and
displaying the three-dimensional globe, the sphere or the cube on top of the particular national or state boundary, and the stick piercing the sphere or the cube on a display panel, which is operatively connected to the computerized system.

16. The method of claim 15, wherein a second member of the first input data set and a second member of the second input data set are associated with another national or another state boundary outside the particular national or state boundary associated with the first member of the first input data and the first member of the second input data set.

17. The method of claim 15, wherein the multivariable input data sets further comprise a third input data set and a fourth input data set.

18. The method of claim 17, further comprising a step of representing a second sphere or a second cube on top of the particular national or state boundary on the three-dimensional globe, wherein the second sphere or the second cube represents a first member of the third input data set, and wherein the second sphere's volume or the second cube's volume represents a magnitude of the first member of the third input data set.

19. The method of claim 18, further comprising a step of representing a second stick erected in the particular national or state boundary piercing the second sphere or the second cube, wherein the second stick piercing the second sphere or the second cube represents a first member of the fourth input data set, and wherein the second stick's height represents a magnitude of the first member of the fourth input data set.

20. The method of claim 15, wherein the three-dimensional globe further includes an inner core underneath the particular national or state boundary with a specific volume that represents an average value, a median value, or another value derived from the multivariable input data sets.
